(19) United States
(12) Patent Application Publication
(10) Pub. No.: US 2020/0327600 A1
(43) Pub. Date: Oct. 15, 2020

(54) METHOD AND SYSTEM FOR PROVIDING PRODUCT RECOMMENDATION TO A USER

(71) Applicant: FalconAI Technologies, Inc., Cambridge, MA (US)

(72) Inventors: Olcay Yilmazcoban, Istanbul (TR); Berk Ozer, Istanbul (TR)

(21) Appl. No.: 16/378,829

(22) Filed: Apr. 9, 2019

(51) Int. Cl. G06Q 30/06; G06Q 50/00; G06N 3/08; G06N 20/00

(52) U.S. Cl. CPC G06Q 30/0631; G06N 20/00; G06N 3/08; G06Q 50/01

(57) ABSTRACT

The invention provides a method and system for providing product recommendation to a user. The method and system includes a data collection module to collect information related to the user from one or more online social networking platforms. Further, a Sweep Learning structure is used for collecting information related to the user by providing a personalized page to the user which includes one or more products, for receiving one or more selections from the user. The one or more selections from the user may include products liked by the user, product categories filtered by the user, and specific products explored or searched by the user. Subsequently, a neural network model is used to learn information related to the user based on information collected from the one or more online social networking platforms and the Sweep Learning structure, and accordingly provide one or more product recommendations to the user.

### FIELD OF THE INVENTION

The invention generally relates to a method and system for providing product recommendation to a user. Specifically, the invention relates to a method and system for providing product recommendation such as, but not limited to, clothing recommendation to the user utilizing a neural network model which learns information such as product likes/dislikes of the user, a style/preference of the user, and product related features based on information collected from one or more online social networking platforms, and a Sweep Learning structure.

### BACKGROUND OF THE INVENTION

Traditional shopping processes involve long-distance travel to locate desirable items of products such as, but not limited to, clothing, apparel, accessories and the like, and checking whether products such as clothes fit the size of a user, by performing a trial. This process is often frustrating and inefficient. To overcome the drawbacks of the traditional shopping process, internet has revolutionized product sales by providing instant access to retail merchants and inventories world-wide. With the introduction of personal computers and other similar technologies, the shopping process has improved significantly, increasing sales volume of products through the online shopping process.

Online or e-commerce-based shopping for products is a popular shopping model, where customers can reach many online shopping web sites and search for products using keywords such as, for example, “black, sleeveless dress” or “gold, watch”. The search typically provides a set of search results to the user based on the search keywords, by matching the keywords with relevant products at the online shopping website. However, the search is limited and the user must sort out the list of items retrieved. Moreover, the user may be interested in searching for a specific product that the user has viewed in a picture or an advertisement, and the user fails to convert characteristics of a desired attire into keywords, to identify similar products based on a photo or a video clip uploaded by the user.

Further, online shopping websites are dependent on various online social networks which are gaining increasing popularity on the internet, to provide easy access to information about users. Current social networking services require a user to manually input their personal preferences and disclose social affiliations, so that the online shopping websites or applications can identify and recommend potential matches for the user based on the user's social circle. However, the manual input process is time consuming and unstructured information acquired by the website or application is inconsistent among different users. Moreover, most of the existing social networks allow the user to upload a variety of file formats such as, but not limited to, photos, video clips, and sound clips, however, the social networks do not extract personal preference information from the multimedia files uploaded by the user.

Therefore, in light of the above, there is a need for a method and system for collecting data from various online social networking platforms and personalized pages using active and passive learning processes to derive user's interests provided to the user, to predict the user's preferences/interests and accordingly recommend finest products to the user.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates a system for providing product recommendation to a user in accordance with an embodiment of the invention.

FIG. 2 illustrates components of an application module for learning user's preferences and interests to enhance the user's experience while providing product recommendations in accordance with an exemplary embodiment of the invention.

FIG. 3 illustrates a flowchart of a method for providing product recommendation to a user in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and system components for providing product recommendation such as, but not limited to, clothing recommendation to the user utilizing a neural network model which learns information such as product likes/dislikes of the user, a style/preference of the user, and product related features based on information collected from one or more online social networking platforms, and a Sweep Learning structure.

Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article or composition that comprises a list of elements does not include only those elements but may include other elements not expressly listed or inherent to such process, method, article or composition. An element proceeded by “comprises . . . a” does not, without more constraints, preclude the existence of additional identical elements in the process, method, article or composition that comprises the element.

Various embodiments of the invention provide a method and system for providing product recommendation to a user. The method and system includes a data collection module for collecting information related to the user from one or more online social networking platforms. Further, the method and system utilizes a Sweep Learning structure for collecting information related to the user. The Sweep Learning structure provides a personalized page to the user which includes one or more products for receiving one or more selections from the user. The one or more selections from the user may include, but need to be limited to, the user liking a product, the user filtering product categories, and the user exploring or searching for specific products. The Sweep Learning structure further extracts product related features utilizing one or more techniques such as, but not limited to, Explore Bandit, Exploit Bandit, and Exploit Offline methods. Subsequently, the method and system utilizes a neural network model to learn information related to the user based on information collected from the one or more online social networking platforms and the Sweep Learning structure. The information includes, but is not limited to, one or more of product likes/dislikes of the user, a style/preference of the user, and product related features. Thereafter, the method and system utilizes a recommendation module to recommend one or more products to the user based on the information learned by the neural network model.

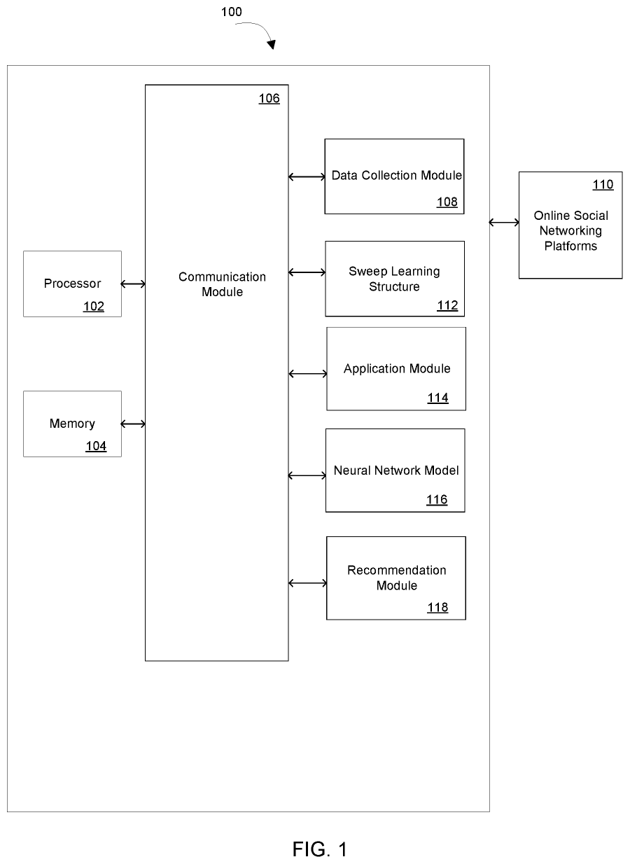

FIG. 1 illustrates a system 100 for providing product recommendation to a user in accordance with an embodiment of the invention. The product recommendation can be, but need not be limited to, clothing recommendation to the user.

As illustrated in FIG. 1, system 100 includes a processor 102 and a memory 104 communicatively coupled to processor 102. Processor 102 and memory 104 further communicate with various modules via a communication module 106. Communication module 106 may be configured to transmit data between modules, engines, databases, memories, and other components of system 100 for use in performing the functions discussed herein. Communication module 106 may include one or more communication types and utilize various communication methods for communication within system 100.

System 100 includes a data collection module 108 for collecting information related to the user from one or more online social networking platforms 110. The information collected from one or more online social networking platforms 110 may include, but need not be limited to, one or more of number of followers of the user, a number of people the user follows, content of posts, photos of the user, hashtags, likes, comments, the user's time consumption on different media, list of favourite items, playlists, different locations that the users posted, and the user's purchases.

One or more online social networking platforms 110 may include, but need not be limited to, an online news and social networking service, a music streaming platform, a photo and video-sharing social networking service, an information discovering web service using smaller images, a business and employment-oriented service, a local search-and-discovery service mobile application, an online social media and social networking service, a video-sharing website, media-services, a mobile commerce service, fashion and lifestyle e-commerce service, a digital distribution platform, an online food ordering service, a location-based social search service, an online audio distribution platform, an online music search engine and a location sharing mobile application.

Once the information is collected from one or more online social networking platforms 110, the information is analysed to extract the user related features. The user related features may include, but need not limited to, likes, dislikes, interests, preferences, style, favourites, user activities and the like.

The user related features are extracted utilizing different image processing techniques and feature extraction techniques. In an instance, if the information collected from the user includes images, the images are analyzed to extract user related features. For example, the user related features are extracted from raw images using Convolutional Neural Networks (CNNs), using a bounding box or segmentation technique. In another instance, if the information collected from the user includes photos/images posted on one or more online social networking platforms 110, features related to the user's appearance such as, but not limited to, height and color, are extracted using image processing techniques.

In yet another instance, if the information collected from the user includes songs or sound/voice records, the user related features are extracted utilizing Long Short-Term Memory (LSTMs), CNNs, high pass/low pass filters, and different feature extraction methods such as, but not limited to, convolving the voice signal with Hamming window and using Fast Fourier Transforms (FFTs) or FFT-Histogram-Multilayer Perceptron (MLPs).

Further, the collected user information is converted into text using LSTMs, and word2vec methods to extract features.

After extracting these features, different methods such as, but not limited to, Principal Component Analysis (PCA), autoencoders, and T-distributed Stochastic Neighbor Embedding (TSNE) are used for feature dimension reduction.

System 100 also includes a Sweep Learning structure 112 which provides a user interface to persuade users to like and dislike proposed products to collect information related to the user. Sweep Learning structure 112 provides a personalized page to the user which includes one or more products, for receiving one or more selections from the user. The one or more selections from the user may include, but need not be limited to, the user liking a product, the user filtering product categories, and the user exploring or searching for specific products.

Sweep Learning structure 112 extracts product related features and user related features using techniques such as, but not limited to, Explore Bandit method, Exploit Bandit method and Exploit Offline method. These techniques are used to maximize total number of likes.

The Explore Bandit method includes techniques such as, but not limited to, LinUCB, Collaborative Bandit, Contextual Zooming, Hierarchical Optimistic optimization, and Thompson Sampling.

LinUCB with high confidence scale constant is used for deciding which items will be shown in Sweep Learning structure 112 to obtain most informative decisions of the users to learn their preferences such as their likes and dislikes, and kernels may be added. On the other hand, Contextual Zooming with high confidence scale and a low/high number of activation rounds, is used to learn preferences of the user.

The Explore Bandit method further includes a Full Exploration Approach. In the Full Exploration Approach, the pages initially display products according to users' likes and dislikes, and in other pages, one or more products are offered to users for learning the style and preferences. The Full Exploration Approach is applied by partitioning feature set of the users into equal parts and selects a product in each partition respectively. Another Full Exploration Approach utilizes LinUCB with a high confidence term scale.

The Exploit Bandit method includes techniques, such as, but not limited to, LinUCB, Contextual Zooming, Hierarchical Optimistic Optimization, Thompson Sampling, Collaborative Bandit, Collaborative Filtering and Neural Network containing methods including, but not limited to, Multi-Layer-Perceptron (MLP).

LinUCB with low confidence scale constant can be used with different Kernel functions such as, but not limited to, Gaussian function and Polynomial function for maximizing number of likes of each user. Contextual Zooming, with low confidence scale and a low number of activation rounds, is used for maximizing number of likes of each user. Additionally, for each user, a Neural Network is generated with one or more hidden layers and the product that has the highest score in the last layer, is chosen for maximizing number of likes of each user.

The Exploit Bandit method further includes Maximizing Click-Through Rate (CTR) approach, to maximize CTR, in other words, maximizing number of likes of each user. In this approach, different varieties of products are selected to learn the user's interests, and at the same time, displaying products that are similar to the products previously liked by the user, to enhance the user's experience. Further, the algorithms used in this approach are based on Multi-Armed-Bandit (MAB) and Collaborative Filtering models which include, but are not be limited to, LinUCBs, Lipschitz MABs, and Collaborative Bandit.

LinUCB is a classical MAB approach for datasets that contain linear relation between context and classes or expected rewards or CTR. Since this relation is rare, a general method to handle this assumption is to use Kernels. After extracting product related features using already trained CNNs or feature extraction methods, Kernels are added and then LinUCB is used directly for improving the user experience. Additionally, scale parameter of the confidence term should be optimized according to responses received from the users.

In the case of Lipschitz MABs, when relation between context and classes or expected rewards or CTR is not linear but complex, it is assumed that this distribution is continuous (Lipschitz). The Contextual Zooming algorithm is then used directly for improving the user experience. Again, a scale parameter of the confidence term should be optimized according to responses received from the users.

In the Collaborative Bandit model, users having similar context are clustered adaptively according to their behavior and number of samples in that cluster. After clustering, a similar approach as that described in LinUCBs is used for clusters instead of individual users.

Exploit Offline method includes CNNs for extracting product related features from raw images. Further, the Exploit Offline method includes techniques such as, but not limited to, attribute prediction, unsupervised learning techniques, image processing techniques, windowed color histograms, similarity learning and offline Sweep Learning structure for extracting product related features.

In attribute prediction techniques, dataset is classified according to predefined attributes using CNN, and semantic features are added to network for enhancing the user's experience. Additionally, the attribute prediction techniques provide a semantic description of each product automatically.

Further, unsupervised learning techniques are used to extract abstract features from the products displayed to the user, and similarity analysis is applied directly to the features for enhancing the user's experience.

The image processing techniques are used to extract product related features from raw images using CNN, using bounding box or segmentation or image processing techniques. In an instance, the images are segmented using super pixels and different filters such as, but not limited to, Gabor filters, minimal/maximal filters, Fourier Transform Low Pass filter, High Pass filter and the like, to extract features from images using image processing techniques.

Further, the windowed color histogram techniques utilize full image and different sized windows to extract product related features from images. A color histogram of full images is used after segmentation or bounding box techniques, and different sized windows are passed through to the full image, wherein the color histogram represents the color features of the image. The aforesaid methods are used to extract features specifically from images.

Similarity learning for products utilizes techniques such as, but not limited to, Mahalanobis Metric, Siamese network, and MLP.

The Mahalanobis Metric can be learned, and distances are calculated by this optimized metric to find similar products. After extracting product related features, neural network model 116 is used for extracting these features if a labeled dataset includes similar products.

The offline Sweep Learning structure includes two different bag structures such as, but not limited to, a sweep bag and a personalized bag, for each user, for collecting products similar to a product liked by the user. When a user likes a product, some of the similar products are pushed to the sweep bag and some of the similar products are pushed to the personalized bag. A size of the personalized bag is limited based on the given input, and when size exceeds the limit, random products from the personalized bag are moved to the sweep bag. Further, the sweep bag used in Sweep Learning structure 112 utilizes the products in the personalized bag for predicting personalized trends.

Sweep Learning structure 112 further includes a chatbot for asking questions to the user for learning the user's preferences based on the answers received from the user. The chatbot enquires the user for different categories of products and different colors of products to filter the products. Sweep Learning structure 112 is also applied while categorizing the products by moving products to the sweep bag and the personalized bag, and proposes the filtered products to the user. Further, the chatbot proposes the products that the user probably likes and searches. The chatbot also proposes specific products to the user, and therefore parameters to decide to run Explore Bandit or Exploit Bandit or Random or Exploit Offline methods are changed and in the probability distribution, probabilities to run the Exploit Bandit and Exploit Offline are increased.

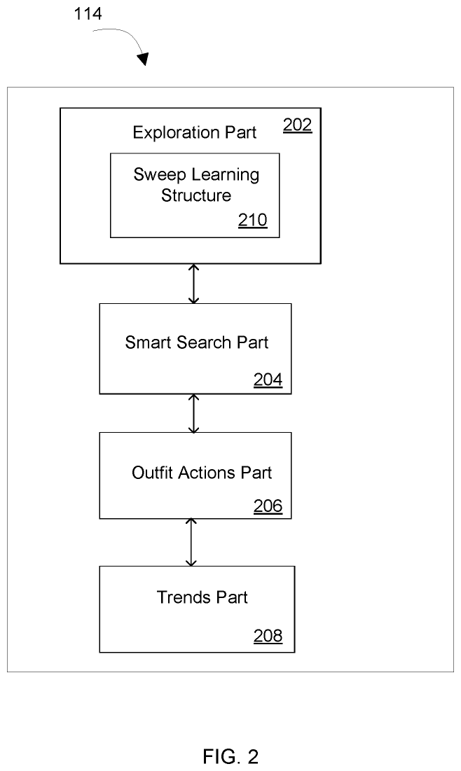

In accordance with an embodiment, system 100 further includes an application module 114 which extracts information 333 pertaining to the user and analyzes the information to learn the user's preferences and interests for enhancing the user's experience while providing product recommendations. Various components of application module 114 are further described in detail in conjunction with FIG. 2.

Moving on, system 100 utilizes a neural network model 116 to learn information related to the user based on information collected from one or more social networking platforms 110 and Sweep Learning structure 112. The information includes, but is not limited to, product likes/dislikes of the user, a style/preference of the user, and product related features.

In an embodiment, neural network model 116 utilizes user related features to optimize the products to be proposed to the user for learning the user's style/preferences based on the user's product selections, and at the same time enhances the user's experience by proposing products that the user likes. Further, neural network model 116 interacts with a dataset which includes possibilities of the user liking a product, and similar products of each of the products, and proposes products according to the user's interests. A probability of the user liking products is generated using techniques such as, but not limited, density estimation methods or MLP, Similarity Search estimated by Siamese network, and Mahalanobis Distance.

Neural network model 116 further utilizes user related features and product related features to estimate probabilities pertaining to whether a user likes or dislikes the specific product. Additionally, neural network model 116 performs a similarity search and saves similar products corresponding to each product. Using these methods, neural network model 116 proposes products to the user by providing identifiers (ids) of the similar products of the product liked by the user, using similarity search methods and probability estimation methods.

System 100 further includes a recommendation module 118 communicatively coupled to neural network model 116. Recommendation module 118 is configured to recommend one or more products to the user based on information learned by neural network model 116. The one or more products recommended to the user may include, but need not be limited to, clothes, ornaments, footwear, cosmetics, and the like.

Recommendation module 118 further predicts like-dislike possibility of each user (by surface generation). Since the information pertaining to each user such as, but not limited to, likes, dislikes, and user related features, obtained from one or more online social networking platforms 110 is available, recommendation module 118 estimates the probabilities of whether the user likes or dislikes a specific product, and uses the information to sort the products in a personalized way. The products are sorted according to the taste of each user, using methods such as, but not limited to, Gaussian Mixture, Density Estimation using low pass filter, and neural network model 116.

Recommendation module 118 also provides recommendations of one or more products via a personalized page, collaborative filtering, similarity search, generating new product using Generative Adversarial Networks (GANs), and predicting moods of the user, in addition to Exploit Offline and Exploit Bandit Methods.

Further, recommendation module 118 predicts future trends by analyzing likes, dislikes of the users, and their behaviour on one or more online social networking platforms 110. Based on obtaining the features and their corresponding histograms, recommendation module 118 predicts trends by applying methods such as, but not limited to, LSTM, Regression with Kernels, and Regularizations, and Clustering Data, to estimate personalized trends.

Also, recommendation module 118 generates correlation between the user related features and product related features to find clusters that are used to improve the predictions of users' actions. Instead of predicting trends for all users, recommendation module 118 provides new trends for each cluster using similar methods as used in surface generation, and instead of using all the data, uses the data in each cluster for training.

Recommendation module 118 also provides recommendation via Collaborative Filtering, for trends, and recommendation by generating new products using GANs, for trends.

Recommendation module 118 generates new products based on the user's information and similarity search, and estimates best products for each user. To generate new products, GANs may also be used. User information can be used as an input of the Generator Network, and a remainder of the process is the same as the traditional process in the GAN. Additionally, users are classified according to defined classes or the data can be clustered and for each cluster or class, different GANs are trained.

In another embodiment, recommendation module 118 proposes trending products by using products that the user likes among all products. For instance, recommendation module 118 proposes trend outfits apart from clothes using the aforesaid techniques, and proposes outfits for each cloth provided in Sweep Learning Structure 112. Firstly, a dataset is collected that contains different outfits which are approved by stylists, and applies similarity learning technique to the clothes. For each cloth in Sweep Learning Structure 112, the most similar clothes and its outfit are identified in the dataset and the clothes that are similar to the determined outfit are proposed to the user.

Finally, to predict moods of the user, a class of moods may be defined and each user is mapped to a class according to the information obtained from one or more online social networking platforms 110. A set of clothes for each style is then prepared. After this preparation, for each class, products that are similar to the products within a class are found to map new-come products to different classes. After determining the classes of each user, the set of clothes are proposed to the user according to its class, via recommendation module 118. The classification is done using techniques such as, but not limited to, MLP and Sup port Vector Machine (SVM).

FIG. 2 illustrates components of application module 114 for learning user's preferences and interests to enhance the user's experience while providing product recommendations in accordance with an exemplary embodiment of the invention.

As illustrated in FIG. 2, application module 114 includes an Exploration Part 202, a Smart Search Part 204, an Outfit Actions Part 206, and a Trends Part 208.

Exploration Part 202 integrates a Sweep Learning Structure 210 that communicates with neural network model 116. In this case, neural network model 116 learns information collected from one or more online social networking platforms 110 and utilizes two different approaches namely an Exploration Approach and Maximizing CTR approach for enhancing the user's experience, and these approaches are adjusted by different parameters. In Exploration Part 202, neural network model 116 is run with a parameter that makes neural network model 116 concentrate more on exploration. Exploration part 202 also uses aforesaid methods such as Explore Bandit method, Exploit Bandit method and Exploit Offline method in Sweep Learning structure 210. The like/dislike information provided by the user are then analyzed to obtain the user's style/preferences when selecting products.

Smart Search Part 204 communicates with Sweep Learning Structure 210, and uses aforesaid methods in the Sweep Learning Structure such as Explore Bandit method, Exploit Bandit method and Exploit Offline method. Additionally, Smart Search Part 204 contains neural network model 116. In this case, neural network model 116 learns information collected from one or more online social networking platforms 110 and information obtained from Sweep Learning Structure 210 and utilizes two different approaches namely an Exploration Approach and Maximizing CTR approach, and these approaches are adjusted by different parameters. In Smart Search Part 204, neural network model 116 is run with a parameter that makes neural network model 116 concentrate more on Maximizing CTR. The like/dislike information provided by the user are then analyzed to obtain user's style/preferences in selecting products.

In Outfit Actions Part 206, users can generate outfits by themselves, and new outfits are proposed by neural network model 116. These are then shown as recommended outfits for each cloth in Sweep Learning Structure 210 or in trends. Outfit Actions Part 206 is connected to recommendation module 118.

Trends Part 208 is also directly connected to recommendation module 118, which generates the trends.

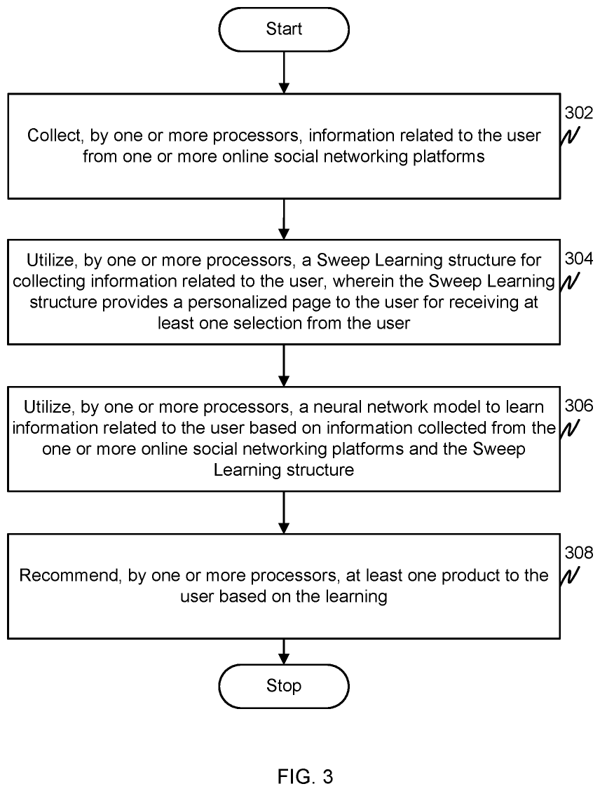

FIG. 3 illustrates a flowchart of a method for providing product recommendation to a user in accordance with an embodiment of the invention.

At step 302, data collection module 108 collects information related to the user from one or more online social networking platforms 110. The information collected from one or more online social networking platforms 110 may include, but need not be limited to, number of followers of the user, a number of people the user follows, content of posts, photos of the user, hashtags, likes, comments, the user's time consumption on different media, list of favourite items, playlists, different locations that the users posted, and the user's purchases.

At step 304, Sweep Learning structure 112 is utilized for collecting information related to the user. Sweep Learning structure 112 provides a personalized page to the user which includes one or more products for receiving one or more product selections from the user. The one or more selections from the user may include, but need not be limited to, the user liking a product, the user filtering product categories, and the user exploring or searching for specific products.

Further, Sweep Learning structure 112 extracts product related features and user related features utilizing techniques such as, but not limited to, Explore Bandit method, Exploit Bandit method and Exploit Offline method. The Explore Bandit method includes techniques such as, but not limited to, LinUCB, Collaborative Bandit, Contextual Zooming, Hierarchical Optimistic Optimization, and Thompson Sampling for extracting product related features. These techniques are used to maximize total number of likes.

The Exploit Bandit method includes techniques, such as, but not limited to, LinUCB, Collaborative Filtering, Contextual Zooming, Hierarchical Optimistic Optimization, Thompson Sampling, Collaborative Bandit, and Multi-Layer-Perceptron (MLP) for maximizing CTR, that is, maximizing number of likes of each user.

The Exploit Offline method includes CNNs for extracting product related features from raw images. Further, the Exploit offline method includes techniques such as, but not limited to, attribute prediction, unsupervised learning techniques, image processing technique, windowed color histograms, similarity learning and offline Sweep Learning structure, for extracting product related features.

The offline Sweep Learning structure includes a sweep bag and a personalized bag for collecting products similar to a product liked by the user. When a user likes a product, some of the similar products are pushed to the sweep bag and some of the similar products are pushed to the personalized bag. A size of the personalized bag is limited based on the given input, and when the size exceeds the limit, random products from the personalized bag are moved to the sweep bag.

Further, Sweep Learning structure 112 includes a chatbot for asking questions to the user for learning the user's style based on the answers received from the user. The chatbot enquires the user for different categories of products and different colors of products to filter the products, and propose specific products to the user.

In an ensuing step 306, neural network model 116 is used to learn information related to the user based on information collected from one or more online social networking platforms 110 and Sweep Learning structure 112. The information includes, but is not limited to, products liked/disliked by the user, a style/preference of the user, and product related features.

Thereafter, at step 308, recommendation module 118 is configured to recommend one or more products to the user based on information learned by neural network model 116. The one or more products recommended to the user may include, but need not be limited to, clothes, ornaments, footwear, cosmetics, and the like.

Recommendation module 118 also provides recommendation of one or more products via a personalized page, collaborative filtering, similarity search, generating new product using GANs, and predicting moods of the user, in addition to Exploit Offline and Exploit Bandit Methods.

The invention describes methods to recommend products based on information related to the users, the information collected from one or more online social networking platforms. The information is related to the users' likes, dislikes, photos, friends (social network), and activities (movie, song or video selections), based on which the users' preferences are predicted during product selections of the user.

Further, the invention correlates the user's preferences and the user's social behavior on one or more online social networking platforms while selecting products such as, but not limited to, clothing, to predict the style of clothing and recommends specific clothes that the users may possibly like. Thus, the invention improves the performance of the recommender systems in the fashion area with specific focus on clothing.

Further, the invention provides efficient mechanisms for collecting user data to provide recommendation of products to users, based on information pertaining to users' behavior and styles, and proposes specific products that the users may possibly like, and generates new trends.

Those skilled in the art will realize that the above recognized advantages and other advantages described herein are merely exemplary and are not meant to be a complete rendering of all of the advantages of the various embodiments of the invention.

The system, as described in the invention or any of its components may be embodied in the form of a computing device. The computing device can be, for example, but not limited to, a general-purpose computer, a programmed microprocessor, a micro-controller, a peripheral integrated circuit element, and other devices or arrangements of devices, which can implement the steps that constitute the method of the invention. The computing device includes a processor, a memory, a non-volatile data storage, a display, and a user interface.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for providing product recommendation to a user, the method comprising:
collecting, by one or more processors, information related to the user from one or more online social networking platforms;
utilizing, by one or more processors, a Sweep Learning structure for collecting information related to the user, wherein the Sweep Learning structure provides a personalized page to the user for receiving at least one selection from the user, the personalized page comprising at least one product and the at least one selection from the user comprises at least one of the user liking a product, the user filtering product categories, and the user exploring or searching for specific products, and wherein the Sweep Learning structure utilizes at least one of Explore Bandit, Exploit Bandit, and Exploit Offline methods for extracting product related features and user related features for maximizing total number of likes;
utilizing, by one or more processors, a neural network model to learn information related to the user based on information collected from the one or more online social networking platforms and the Sweep Learning structure, wherein the information includes at least one of product likes/dislikes of the user, a style/preference of the user, and product related features; and
recommending, by one or more processors, at least one product to the user based on the learning.

2. The method of claim 1, wherein a product recommendation to the user is a clothing recommendation.

3. The method of claim 1, wherein the information collected from the one or more online social networking platforms comprises at least one of a number of followers of the user, a number of people the user follows, content of posts, photos of the user, hashtags, likes, comments, the user's time consumption on different media, a list of favorite items, playlists, different locations that the users posted, and the user's purchases.

4. The method of claim 1, wherein the Explore Bandit method comprises at least one of LinUCB, Collaborative Bandit, Contextual Zooming, Hierarchical Optimistic Optimization and Thompson Sampling.

5. The method of claim 1, wherein the Exploit Bandit method comprises at least one of LinUCB, Collaborative Filtering, Contextual Zooming, Hierarchical Optimistic Optimization, Thompson Sampling, Collaborative Bandit, and a Neural Network.

6. The method of claim 1, wherein the Exploit Offline method comprises Convolutional Neural Networks (CNNs) for extracting product related features from raw images.

7. The method of claim 1, wherein the Exploit Offline method comprises attribute prediction, unsupervised learning techniques, image processing methods, windowed color histograms, similarity learning, and offline Sweep Learning structure.

8. The method of claim 7, wherein the offline Sweep Learning structure comprises a sweep bag and a personalized bag for collecting products similar to a product liked by the user.

9. The method of claim 1, wherein the Sweep Learning structure comprises a chatbot system for asking questions to the user for learning the user's style based on the answers received from the user.

10. The method of claim 1, wherein the recommending comprises providing, by one or more processors, recommendation of the at least one product via at least one of a personalized page, collaborative filtering, similarity search, generating new product using Generative Adversarial Networks (GANs), and predicting moods of the user.

11. A system for providing product recommendation to a user, the system comprising:
a memory;
a processor communicatively coupled to the memory, wherein the processor is configured to:
collect information related to the user from one or more online social networking platforms;
utilize a Sweep Learning structure for collecting information related to the user, wherein the Sweep Learning structure provides a personalized page to the user for receiving at least one selection from the user, the personalized page comprising at least one product and the at least one selection from the user comprises at least one of the user liking a product, the user filtering product categories, and the user exploring or searching for specific products, and wherein the Sweep Learning structure utilizes at least one of Explore Bandit, Exploit Bandit, and Exploit Offline methods for extracting product related features and user related features for maximizing total number of likes;
utilize a neural network model to learn information related to the user based on information collected from the one or more online social networking platforms and the Sweep Learning structure, wherein the information includes at least one of product likes/dislikes of the user, a style/preference of the user, and product related features; and
recommend at least one product to the user based on the learning.

12. The system of claim 10, wherein a product recommendation to the user is a clothing recommendation.

13. The system of claim 10, wherein the information collected from the one or more online social networking platforms comprises at least one of number of followers of the user, a number of people the user follows, content of posts, photos of the user, hashtags, likes, comments, the user's time consumption on different media, list of favorite items, playlists, different locations that the users posted, and the user's purchases.

14. The system of claim 10, wherein the Explore Bandit method comprises at least one of LinUCB, Collaborative Bandit, Contextual Zooming, Hierarchical Optimistic Optimization, and Thompson Sampling.

15. The system of claim 10, wherein the Exploit Bandit method comprises at least one of LinUCB, Collaborative Filtering, Contextual Zooming, Hierarchical Optimistic Optimization, Thompson Sampling, Collaborative Bandit, and a Neural Network.

16. The system of claim 10, wherein the Exploit Offline method comprises Convolutional Neural Networks (CNNs) for extracting product related features from raw images.

17. The system of claim 10, wherein the Exploit Offline method comprises attribute prediction, unsupervised learning techniques, image processing methods, windowed color histograms, similarity learning, and offline Sweep Learning structure.

18. The system of claim 17, wherein the offline Sweep Learning structure comprises a sweep bag and a personalized bag for collecting products similar to a product liked by the user.

19. The system of claim 10, wherein the Sweep Learning structure comprises a chatbot system for asking questions to the user for learning the user's style based on the answers received from the user.

20. The system of claim 10, wherein the processor is configured to provide recommendation of the at least one product via at least one of a personalized page, collaborative filtering, similarity search, generating new product using Generative Adversarial Networks (GANs), and predicting moods of the user.
